(19) United States
(12) Patent Application Publication
(10) Pub. No.: US 2026/0229077 A1
(43) Pub. Date: Aug. 6, 2026

(54) MODULAR LOCK ASSEMBLY FOR A VEHICLE STORAGE BIN

(71) Applicant: Ford Global Technologies, LLC, Dearborn, MI (US)

(72) Inventors: Jonathan Miguel Garcia Santos, Tecámac (MX); Mauricio Magana, Mexico City (MX); Jorget Rincon Ccorahua, Mexico City (MX); Luis Guerrero, Chiautempan (MX); Nathali Vasquez Henao, Mexico City (MX); Alanis Esteban Virgen, Monterrey (MX); Matthew Styx, Romulus, MI (US); Jesus Edgar Castro Ramos, Chihuahua (MX)

(73) Assignee: Ford Global Technologies, LLC, Dearborn, MI (US)

(21) Appl. No.: 19/045,095

(22) Filed: Feb. 4, 2025

(51) Int. Cl. G07C 9/00; B60R 7/04

(52) U.S. Cl. CPC G07C 9/00896; B60R 7/04; G07C 9/00944; G07C 2009/00825; G07C 2009/00841

(57) ABSTRACT

A lock assembly for a vehicle storage bin includes a striker configured to be assembled onto one of a storage bin housing and a door. A latch is configured to be assembled onto the other of the storage bin housing and the door. The lock assembly further includes a signal receiver circuitry to receive a control signal and an actuator for actuating the latch relative to the striker to lock and unlock the latch from the striker in response to the control signal.

### FIELD OF THE DISCLOSURE

The present disclosure generally relates to storage assemblies for vehicles, and more particularly relates to a lock assembly for use on a motor vehicle storage bin.

### BACKGROUND OF THE DISCLOSURE

Motor vehicles are commonly equipped with one or more storage compartments including a glovebox and a center console, for example. The storage compartment typically includes a door that is configurable to cover and thereby close the storage compartment. It would be desirable to equip a storage bin for a vehicle with an efficient lock assembly configured to effectively secure cargo items stored in the storage compartment.

### SUMMARY OF THE DISCLOSURE

According to a first aspect of the present disclosure, a lock assembly for a vehicle storage bin may include a striker configured to be assembled onto one of a storage bin housing and a door. A latch is configured to be assembled onto the other of the storage bin housing and the door. The lock assembly may further include a signal receiver circuitry to receive a control signal and an actuator for actuating the latch relative to the striker to lock and unlock the latch from the striker in response to the control signal.

Embodiments of the first aspect of the present disclosure can include any one or a combination of the following features:
the signal receiver circuitry receives a user input from a remote control device;
the remote control device comprises a phone;
the phone is configured to operate application software;
the lock assembly is configured to be moved to another vehicle storage bin;
the latch is configured to be installed on the door that moves between an open
position exposing a storage compartment of the vehicle storage bin and a closed position covering the storage compartment of the vehicle storage bin, and the striker is located on the housing;
the latch is configured to be disassembled from the door, and the striker is configured to be disassembled from the housing;
the latch comprises a rotating locking arm, and the striker comprises a striker bar;
the striker has a striker mounting arm configured to engage the one of the storage bin housing and the door and the latch has a latch mounting arm configured to engage a first receiver on one of the other of the storage bin housing and the door; and
the vehicle storage bin comprises one of a center console, a glovebox and a rear cargo storage bin.

According to a second aspect of the present disclosure, a vehicle storage bin may include a housing, a first receiver coupled to the housing, a door, a second receiver coupled to the door, a latch installed on one of the first and second receivers, a striker installed on the other of the first and second receivers, a signal receiver circuitry receiving a control signal, and an actuator for actuating the latch with an actuator between locked and unlocked positions in response to the control signal.

Embodiments of the second aspect of the present disclosure can include any one or a combination of the following features:
the signal receiver circuitry receives the control signal as a user input from a remote control device;
the remote control device comprises a phone;
the phone is configured to operate application software;
the lock assembly is configured to be moved to another vehicle storage bin;
the latch is configured to be installed on the door that moves between an open position exposing a storage compartment of the storage bin and a closed position covering the storage compartment of the storage bin, and the striker is located on the housing;
the latch is configured to be disassembled from the door, and the striker is configured to be disassembled from the housing;
the striker has a striker mounting arm configured to engage the one of the storage bin housing and the door and the latch has a latch mounting arm configured to engage a first receiver on one of the other of the storage bin housing and the door; and
the latch comprises a rotating locking arm, and the striker comprises a striker bar.

According to a third aspect of the present disclosure, a vehicle includes a storage bin. The storage bin may include a housing, a first receiver coupled to the housing, a door, a second receiver coupled to the door, and a lock assembly. The lock assembly comprises a latch installed on one of the first and second receivers, a striker installed on the other of the first and second receivers, a signal receiver circuitry receiving a control signal, and an actuator for actuating the latch with an actuator between locked and unlocked positions in response to the control signal.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a forward looking upper perspective view of a front portion of a cabin interior of a motor vehicle having a plurality of storage bins, each configured to be equipped with a lock assembly, according to one example;

FIG. 2 is a rear perspective view of the motor vehicle with the lift gate in an open position exposing a rear cargo area having a storage bin with a lock assembly, according to one example;

FIG. 3 is an upper rear perspective view of a storage bin configured as a glove box having the door in the closed position;

FIG. 3A is an upper rear perspective view of the storage bin shown in FIG. 3 with the door in the open position;

FIG. 3B is an upper rear perspective view of a storage bin shown in FIG. 3 in the open door position with the lock assembly disassembled from the storage bin;

FIG. 4 is a rear perspective view of the lock assembly installed on the storage bin and illustrated in a locked position;

FIG. 4A is a cross-sectional view taken through line IVA-IVA of FIG. 4;

FIG. 5 is a rear perspective view of the lock assembly installed on the storage bin and illustrated in an unlocked position;

FIG. 5A is a cross-sectional view taken through line VA-VA of FIG. 5;

FIG. 6 is a rear perspective view of the striker in FIG. 5 disengaged from the latch in the unlocked position;

FIG. 6A is a cross-sectional view taken through line VIA-VIA of FIG. 6;

FIG. 7 is an exploded perspective view of the lock assembly;

FIG. 8 is an elevated perspective view of the striker aligned to be assembled onto a first U-shaped receiver on the housing;

FIG. 9 is an elevated perspective view of the latch aligned to be received in a second U-shaped receiver on the door; and

FIG. 10 is a block diagram illustrating controls for controlling an actuator to lock and unlock the lock assembly.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

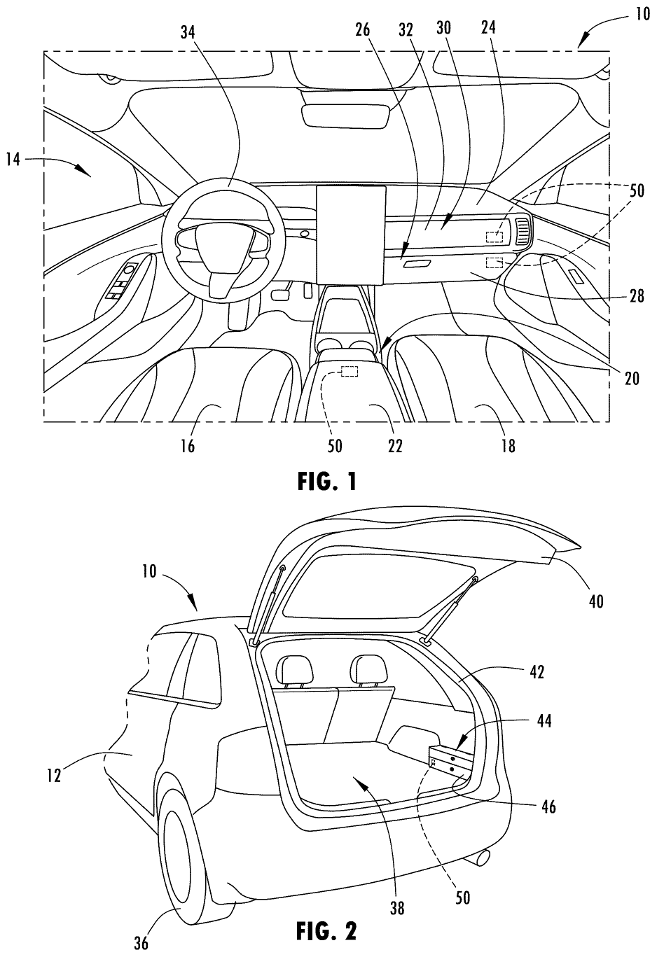

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a lock assembly for a vehicle storage bin. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-10, a cabin interior 14, also referred to as a passenger compartment, of a motor vehicle 10 is generally equipped with a plurality of storage bins, each equipped to receive a lock assembly 50 for the corresponding vehicle storage bin. The lock assembly 50 includes a striker 62 configured to be assembled onto one of a storage bin housing and a door. The lock assembly 50 also includes a latch 60 configured to be assembled onto the other of the storage bin housing and the door. The lock assembly 50 includes signal receiver circuitry for receiving a control signal and an actuator for actuating the latch relative to the striker to lock and unlock the latch from engagement with the striker. The lock assembly 50 may be assembled onto any of a number of one or more vehicle storage bins and may be disassembled from one storage bin and moved to and reassembled onto another storage bin.

With particular reference to FIGS. 1 and 2, the cabin interior 14 of the motor vehicle 10 is illustrated generally defined by a body 12 which may include body panels, doors such as lateral passenger doors and a rear liftgate 40, windows, a floor and a roof. The cabin interior 14 is further illustrated equipped with a seating arrangement having a plurality of seats such as a front row driver's seat 16 for seating a driver of the motor vehicle 10 and a front row passenger seat 18. It should be appreciated that the motor vehicle 10 may include any of a number of seats, including the front row of seats and one or more rear rows of seats.

The cabin interior 14 is further illustrated having a steering wheel 34 generally located forward of the driver's seat 16 and a dashboard 24 that generally extends laterally along a front portion of the cabin interior 14 forward of the steering wheel 34 between lateral left and right sides of the motor vehicle 10. The driver's seat 16 and front row passenger seat 18 are proximate to side doors that open to allow access to the cabin interior 14 and the seating arrangement.

The motor vehicle 10 is shown in one example equipped with a plurality of storage bins including a first storage bin 20 commonly referred to as a center console, a second storage bin 26 commonly referred to as a glove box, a third storage bin 30 located above the second storage bin, and a fourth storage bin 44 located in a rear cargo area 38 of the motor vehicle 10. One or more of the first, second, third and fourth storage bins 20, 26, 30 and 44, may be equipped with a lock assembly 50 for locking the corresponding storage bin in a closed door locked position to prevent access to the corresponding storage bin. The first, second, third and fourth storage bins 20, 26, 30 and 44, shown in FIGS. 1 and 2, each is configured to receive a lock assembly 50. It should be appreciated that the lock assembly 50 may be located on one or more of the first, second, third, and fourth storage bins 20, 26, 30, and 44, and that the lock assembly 50 may be disassembled and reassembled onto another of the storage bins to accommodate preferential locking of the storage bins for securing cargo for users.

The first storage bin 20 is shown configured as a center console located generally between the driver's seat 16 and the front row passenger seat 18. The center console configured first storage bin 20 may extend forward toward the dashboard 24 and may extend up to the dashboard, in some examples. The first storage bin 20 generally has a housing generally defining a storage compartment on the interior and a door 22, also referred to as a lid or an armrest lid, that is hingedly connected to the housing and configured to move between an open position allowing access to the storage compartment and a closed position covering the storage compartment. The lock assembly 50 includes a latch and striker assembled onto the housing and door 22 to securely lock the door 22 in the closed position to prevent unauthorized opening of the door 22.

The second storage bin 26 is shown configured as a glovebox generally installed within or below a lower rear portion of the dashboard 24 generally forward of the front row passenger seat 18. The second storage bin 26 likewise has a housing that allows access to a storage compartment which is integrated with a door 32, according to one example. The second storage bin 26 is configured to include a lock assembly 50 which includes a latch and a striker assembled onto the housing and the door to lock the door in the closed position to prevent unauthorized opening of the door to thereby block access to the storage compartment.

The third storage bin 30 is shown located above the second storage bin 26 within an upper portion of the dashboard 24 generally forward of the front row passenger 18. The third storage bin 30 likewise includes a storage compartment built into a housing and a door that is hingedly connected to the housing and moves between the open and closed positions. The third storage bin 30 is configured to include a lock assembly 50 with a latch and striker assembled onto the door and the housing to lock the door in the closed position to prevent unauthorized opening of the door and therefore preventing access to the storage compartment.

The fourth storage bin 44 is shown located along a lateral sidewall of the rear cargo area 38 of the motor vehicle 10. The fourth storage bin 44 is accessible when a liftgate 40 at the rear end of the motor vehicle 10 is raised in the open position as shown in FIG. 2 exposing the rear cargo area 38 which is rearward of the rearward most row of seating. The fourth storage bin 44 includes a housing defining a storage compartment and having a door 46 hingedly connected to the housing and the door 46 moves between open and closed positions. The fourth storage bin 44 likewise is configured to have a lock assembly 50 with a latch and striker assembled onto the housing and door 46 to lock the door 46 in the closed position to prevent unauthorized opening of the door, thereby preventing access to the storage compartment.

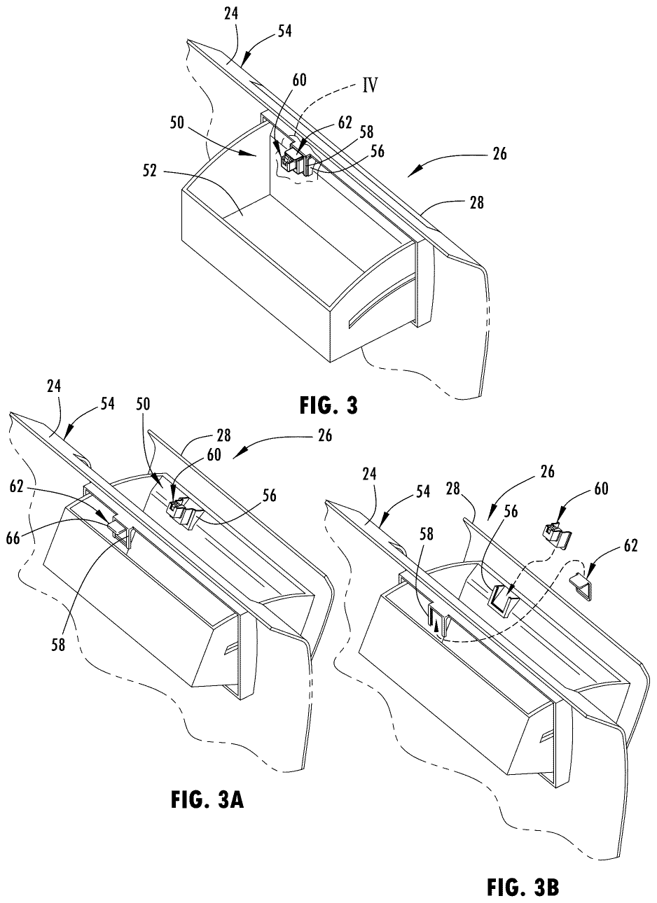

The arrangement of the lock assembly 50 onto one of the storage bins is illustrated in FIGS. 3-3B where the second storage bin 26 is configured in one example as a glovebox. In the glovebox configuration, the second storage bin 26 has a storage compartment 52 assembled with the door 28 at the front side thereof. The storage compartment 52 and the door 28 which is connected to or formed therewith to rotate within an opening in housing 54 which may be part of the dashboard 24 to move between a closed position preventing access to the storage compartment 52 shown in FIG. 3, and open positions exposing the storage compartment 52 shown in FIGS. 3A and 3B. In the closed position, the door 28 on the second storage bin 26 completely blocks access to the storage compartment 52. With the door 28 rotated vehicle rearward to the open position, the storage compartment 52 extends rearward of housing 54 and is exposed to allow access thereto.

The lock assembly 50 includes a latch 60 and a striker 62 configured to lockingly engage the latch 60. The latch 60 is shown in FIG. 3B configured to be assembled onto a first receiver 56 provided on or connected proximate to the door 28, and the striker 62 is configured to be assembled onto a second receiver 58 provided on or connected proximate to the housing 54. A vehicle equipment installer or a user may install the latch 60 onto the first receiver 56 and may disassemble the latch 60 from the first receiver 56 for use on another storage bin. Similarly, a vehicle equipment installer or a user may install the striker 62 onto the second receiver 58 and may disassemble the striker 62 from the second receiver 58 and move the striker 62 to another storage bin. Hence, the lock assembly 50 may be transferrable.

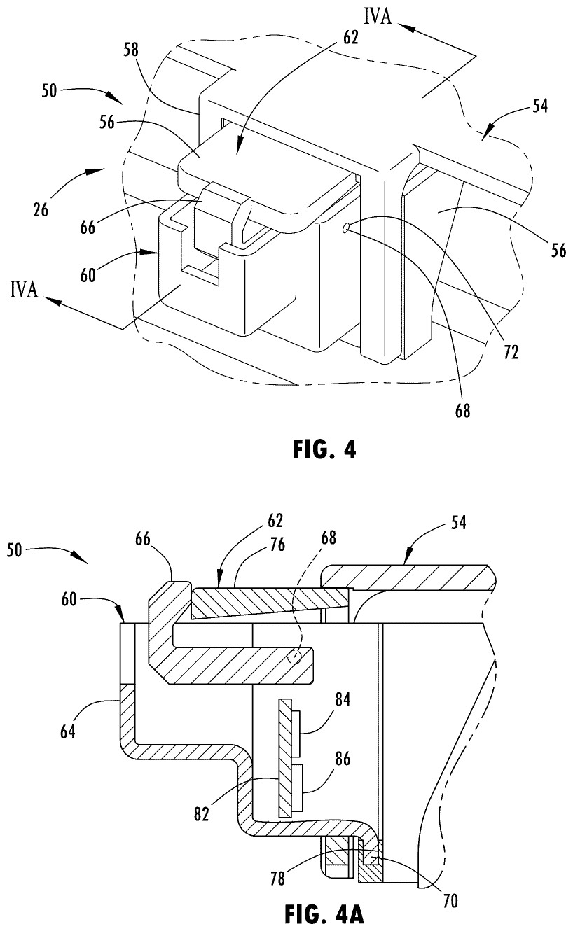

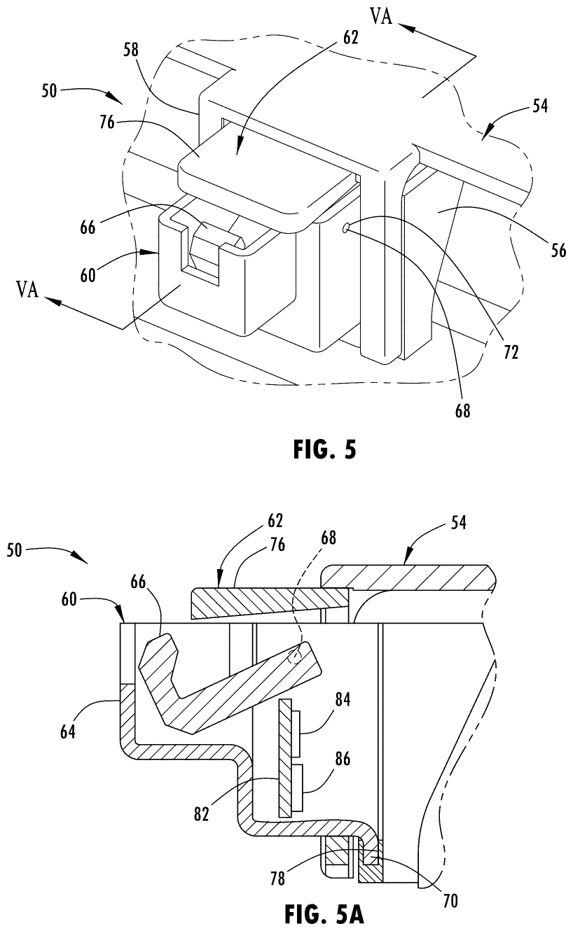

The lock assembly 50 is shown in FIGS. 4 and 4A in a locked position locking the door 28 onto the housing 54 of a storage bin 26. The striker 62 has a striker bar 76 positioned to be engaged by a locking arm 66 on the latch 60 when in the locked position. The latch 60 has the locking arm 66 configured in one example in a generally J-shaped configuration and rotatable about an actuatable drive shaft 68. As such, an actuator may actuate the drive shaft 68 to rotate the locking arm 66 between the locked position engaging the striker bar 76 shown in FIGS. 4 and 4A, and an unlocked position disengaged and free of the striker bar 76 shown in FIGS. 5 and 5A. With the locking arm 66 disengaged from the striker bar 76 of striker 62, the door 28 is free to move to the open position to allow access to the storage compartment. The opening of the door 28 may include a user unlatching a latch or releasing a magnet with force, for example.

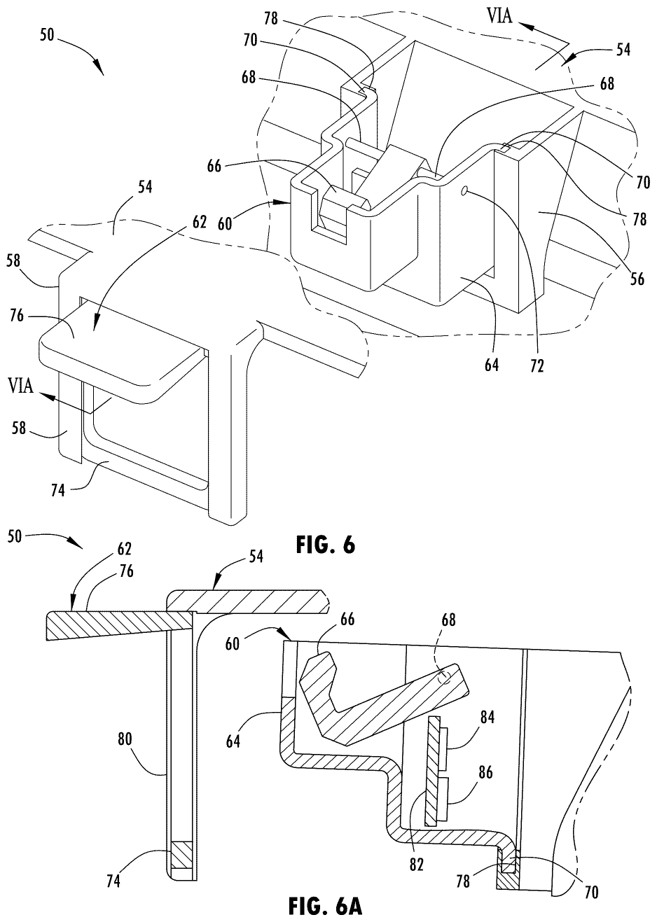

The latch 60 and striker 62 are shown disengaged from one another with the door 28 partially open relative to the housing in FIGS. 6 and 6A. With the locking arm 66 disengaged from the striker bar 76, the door 28 is free to move and separate from the housing 54 to expose the storage compartment.

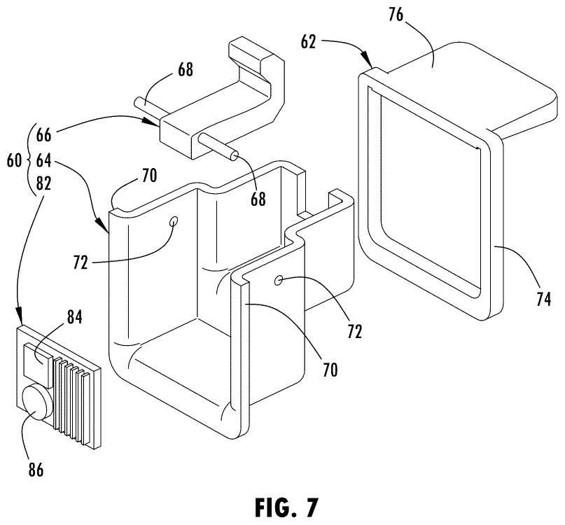

Referring to FIG. 7, the lock assembly 50 is further illustrated in a disassembled view. The striker 62 includes a mounting arm 74 which is generally shown in a U-shaped configuration. The mounting arm 74 is configured to engage and be installed onto one of the first and second receivers 56 and 58 during installation onto one of the door and housing. The striker bar 76 is shown in one example extending perpendicular to the mounting arm, however, it should be appreciated that other configurations of the striker may be possible.

The latch 60 is shown having a latch housing 64 which includes opposite sidewalls and a pair of holes 72 on the opposite sidewalls for receiving the actuable drive shaft 68 of the locking arm 66. As such, the locking arm 66 rotates in response to rotation of the drive shaft 68 supported on the latch housing 64. It should be appreciated that the drive shaft 68 may be coupled to an actuator, such as a motor or electromagnetic device, to rotate the locking arm 66 between the locked and unlocked positions. The latch housing 64 further includes a mounting arm 70 in a generally U-shaped configuration which is configured to be received within one of the first and second receivers 56 and 58 in the door and housing during the installation.

The lock assembly 50 further includes signal receiver circuitry 84 which is shown mounted on a printed circuit board (PCB) 82. The printed circuit board 82 may be mounted within the latch housing 64. The signal receiver circuitry 84 may include wireless communication circuitry configured to receive wireless communication signals such as Bluetooth or Wi-Fi signals, for example. The signal receiver circuitry 84 may communicate with an actuator, such as a motor 86, which may be operatively coupled to the drive shaft 68 to rotate the locking arm 66 between locked and unlocked positions. It should be appreciated that the signal receiver circuitry 84 receives electrical power which may be supplied via the vehicle electrical distribution system or a portable power source such as a battery.

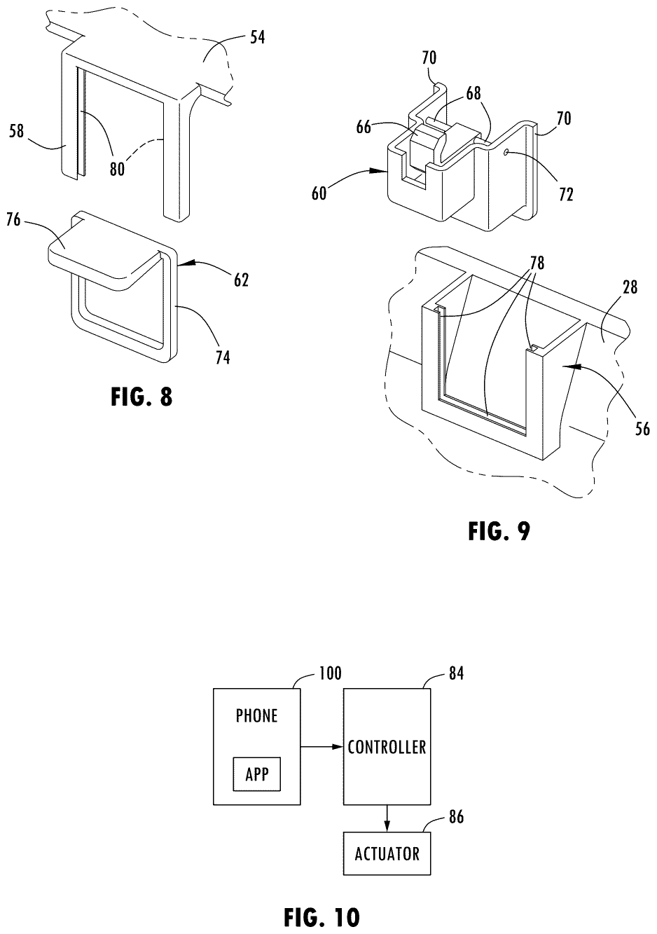

The striker 62 is shown in FIG. 8 aligned to be assembled onto a first receiver 56 of housing 54. In doing so, the mounting arm 74 is aligned with the first receiver 56 which is shown having a U-shaped slot 80 receiving the mounting arm 74. The latch 60 is aligned with the second receiver 58 on door 28 as shown in FIG. 9, such that the latch 60 is installed in a U-shaped slot 78 of second receiver 58 during assembly. It should be appreciated that the striker 62 and latch 60 may be installed into the respective first and second receivers 56 and 58 having slots 78 and 80 corresponding to a storage bin and may be disassembled and reassembled onto first and second receivers 56 and 58 on another storage bin such that the lock assembly 50 is transferrable. The striker 62 and the latch 60 may be retained in the first and second receivers 56 and 58 due to a frictional connection and/or with a fastener.

Referring to FIG. 10, the lock assembly 50 may be controlled by a user to lock and unlock the lock assembly 50. In one embodiment, the lock assembly 50 may be controlled by a user using a remote control device, such as a phone 100, using an application (app) software. In doing so, the phone may communicate via wireless communication with a controller 84 such as via Bluetooth or Wi-Fi. The controller 84 may receive a user control input signal and control the actuator 86 to rotate the locking arm 66 to lock or unlock the lock assembly 50 to thereby allow access or block access to the storage compartment. It should be appreciated that other user inputs such as a key fob input, a tablet or a computer generated input may be employed to control the operation of the lock assembly 50.

Accordingly, a lock assembly 50 for a vehicle storage bin 20, 26, 30 and 44 is provided which advantageously provides for the securement of cargo within a motor vehicle 10. The lock assembly 50 may be controlled via a remote control device to lock or unlock the lock assembly 50 to control access to a storage compartment. The lock assembly 50 may advantageously be easily installed onto a housing and door and may be selectively moved and installed on another storage bin by a user.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A lock assembly for a vehicle storage bin, the lock assembly comprising:
a striker configured to be assembled onto one of a storage bin housing and a door;
a latch configured to be assembled onto the other of the storage bin housing and the door;
signal receiver circuitry to receive a control signal; and
an actuator for actuating the latch relative to the striker to lock and unlock the latch from the striker in response to the control signal.

2. The lock assembly of claim 1, wherein the signal receiver circuitry receives a user input from a remote control device.

3. The lock assembly of claim 2, wherein the remote control device comprises a phone.

4. The lock assembly of claim 3, wherein the phone is configured to operate application software.

5. The lock assembly of claim 1, wherein the lock assembly is configured to be moved to another vehicle storage bin.

6. The lock assembly of claim 1, wherein the latch is configured to be installed on the door that moves between an open position exposing a storage compartment of the vehicle storage bin and a closed position covering the vehicle storage compartment of the storage bin, and the striker is located on the housing.

7. The lock assembly of claim 6, wherein the latch is configured to be disassembled from the door, and the striker is configured to be disassembled from the housing.

8. The lock assembly of claim 1, wherein the latch comprises a rotating locking arm, and the striker comprises a striker bar.

9. The lock assembly of claim 1, wherein the striker has a striker mounting arm configured to engage the one of the storage bin housing and the door and the latch has a latch mounting arm configured to engage a first receiver on one of the other of the storage bin housing and the door.

10. The lock assembly of claim 1, wherein the vehicle storage bin comprises one of a center console, a glovebox and a rear cargo storage bin.

11. A vehicle storage bin comprising:
a housing;
a first receiver coupled to the housing;
a door;
a second receiver coupled to the door;
a latch installed on one of the first and second receivers;
a striker installed on the other of the first and second receivers;
a signal receiver circuitry receiving a control signal; and
an actuator for actuating the latch with an actuator between locked and unlocked positions in response to the control signal.

12. The vehicle storage bin of claim 11, wherein the signal receiver circuitry receives the control signal as a user input from a remote control device.

13. The vehicle storage bin of claim 12, wherein the remote control device comprises a phone.

14. The vehicle storage bin of claim 13, wherein the phone is configured to operate application software.

15. The vehicle storage bin of claim 11, wherein the lock assembly is configured to be moved to another vehicle storage bin.

16. The vehicle storage bin of claim 11, wherein the latch is configured to be installed on the door that moves between an open position exposing a storage compartment of the storage bin and a closed position covering the storage compartment of the storage bin, and the striker is located on the housing.

17. The vehicle storage bin of claim 16, wherein the latch is configured to be disassembled from the door, and the striker is configured to be disassembled from the housing.

18. The vehicle storage bin of claim 11, wherein the latch comprises a rotating locking arm, and the striker comprises a striker bar.

19. The vehicle storage bin of claim 11, wherein the striker has a striker mounting arm configured to engage the one of the storage bin housing and the door and the latch has a latch mounting arm configured to engage a first receiver on one of the other of the storage bin housing and the door.

20. A vehicle comprising:
a storage bin comprising:
a housing;
a first receiver coupled to the housing;
a door;
a second receiver coupled to the door; and
a lock assembly comprising:
a latch installed on one of the first and second receivers;
a striker installed on the other of the first and second receivers;
a signal receiver circuitry receiving a control signal; and
an actuator for actuating the latch with an actuator between locked and unlocked positions in response to the control signal.
